(19) United States
(12) Patent Application Publication
(10) Pub. No.: US 2006/0034966 A1
(43) Pub. Date: Feb. 16, 2006

(54) Device for cooling and calibrating plastic profiled pieces

(76) Inventor: Meinhard Schwaiger, Linz (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/533,898

(22) PCT Filed: Oct. 30, 2003
(86) PCT No.: PCT/AT03/00323

§ 371 Date: Aug. 11, 2005

(30) Foreign Application Priority Data
Nov. 8, 2002 (AT) A 1688/2002

(51) Int. Cl. B29C 47/00

(52) U.S. Cl. 425/326.1; 425/388

(57) ABSTRACT

The invention relates to a device for cooling and calibrating plastic profiled pieces, comprising a housing (13) that has an entry opening and an exit opening for the profiled piece (8) to be treated, and comprising a sleeve (12), which it is placed inside the housing, connects the entry opening to the exit opening, and which surrounds a passageway (24) that essentially corresponds to the outer contour of the profiled piece (8) while enabling the profiled piece (8) to be guided therein. Said sleeve, in essence, completely surrounds the profiled piece in the area of the device. The inventive device also comprises a vacuum system for generating a vacuum inside the gap between the profiled piece (8) and the sleeve (12) that is connected to openings (14, 15), which have small dimensions and are provided in the sleeve (12). Finally, the device comprises at least one interior space (25), which is filled with a cooling medium when the device is in operation and which is connected to an inflow opening (17) and to an outflow opening (18) for a cooling medium in order to produce a flow of the cooling medium inside the interior space (25). An improved cooling capacity can be achieved by virtue of the fact that the sleeve (12) has at least one thin-walled section, which separates the passageway (24) from the interior space (25), and that openings (14, 15) are provided in this section that connect the passageway (24) to the interior space (25).

The invention relates to a device for cooling and calibrating plastic profiles, comprising
a housing having an entry opening and an exit opening for the profile to be processed; and
a sleeve disposed within the housing, which connects the entry opening and the exit opening and encloses a passage essentially corresponding to the outer contour of the profile and containing the profile to be guided, said sleeve completely surrounding the profile inside the device; and
a vacuum system for generating a vacuum In the gap between profile and sleeve, which is connected to small openings provided in the sleeve; and
at least one interior space, which Is filled with a cooling medium during operation of the device and is provided with an Inflow opening and an outflow opening for the cooling medium such that a flow of the cooling medium can be generated in the interior space.

Devices of this type are usually called dry calibrators since the profile is not in direct contact with the cooling medium. Such dry calibrators are usually placed directly downstream of the extrusion nozzle and upstream of calibrating tanks in which the profile is guided through a water bath.

In the first calibrating step the very soft profile stream, which does not yet have sufficient intrinsic stability, is guided through the dry calibrator, where the vacuum causes the surface of the soft plastic profile stream to come into contact with the interior surface of the metal body of the calibrator, The metal body is provided with suitably configured conduits, preferably located near the interior surface of the metal calibrating body, through which a cooling medium flows, i.e. preferably cooling water, whereby a heat transfer from the profile is achieved in addition to exact calibration of the profile. Due to strict requirements regarding the optical properties of the surface of the plastic profile the cooling and calibrating process in this first step must be carried out in a completely dry manner. After a first cooling period which depends on the extrusion speed, the wall thickness of the profile and the processing temperature of the molten plastic material, a firm exterior layer of the plastic profile stream is built up, giving it a first Intrinsic stability. Starting from the point in time when sufficient intrinsic stability (a sufficiently cooled and rigidified exterior layer) is achieved, the profile stream in a second step may be cooled to its final temperature, usually ambient temperature, in a cooling tank in which the profile stream is immersed in a cooling medium and, if required, exposed to a vacuum. For the production of hollow profiles such calibrating tanks are designed as vacuum tanks with turbulent flow of the cooling medium and with a set of so-called supporting or calibrating apertures. For the production of simpler or open profiles an open-surface water bath is used.

Due to the unfavourable heat conduction properties of the thick-walled metal bodies cooling of the profile surface is slow and uneven in comparison to the direct heat transfer from the profile stream when the profile is in immediate contact with the cooling medium. A further disadvantage lies in the higher manufacturing cost of a metal calibrator as compared with a calibrating tank system. Yet another disadvantage of conventional dry calibrators stems from the fact that generating the required vacuum In the vacuum slits or vacuum chambers entails huge energy consumption on account of flow losses and due to the fact that the vacuum pumps used for vacuum generation can only be controlled with difficulty and in a small range because of unfavourable pump characteristics. As an example it may be mentioned that the energy required for operation of the vacuum pumps amounts to roughly 70-80% of the total energy requirement of a calibrating table.

From the applicant's EP 0 925 905 A a device for the cooling and calibrating of extruded plastic profiles is known. This device uses wet calibration, with the profile being, along a stretch of its path, in direct contact with the cooling medium contained within the device. In this way excellent heat transfer between the profile and the cooling medium is ensured and rapid cooling is achieved. In order to avoid undesirable widening of the profile due to the vacuum present in the interior of the device on the upstream side, the water tank is provided with calibrating sleeves which can support the profile walls over their area. The profile itself is in contact with the cooling water along the whole length of the device, thus permitting the use of this known device only downstream of conventional dry calibrators, in which a first cooling and rigidifying of the profile occurs, Such dry calibrators however have the disadvantages cited above.

GB 1 202 961 A describes a calibrating device for plastic pipes with a calibrating tool comprising vacuum chambers. These vacuum chambers are connected to the interior passage of the calibrating sleeve via orifices in order to suck the exterior contour of the pipe against the sleeve. Furthermore a cooling water chamber is provided in the tool in the usual manner for rapid dissipation of the heat of the pipe profile stream. Thus this known tool comprises a vacuum system and a water cooling system which is separated from the vacuum system. This results in a complex design and the cooling performance in the area of the vacuum chambers is degraded.

It is the object of the present invention to propose a novel calibrating system which avoids the above cited disadvantages of state-of-the-art dry calibrators and which, due to improved cooling performance, permits a reduction In the required number of dry calibrators and thus in the overall length of the calibrating set-up.

It is a further object of the invention to propose a method and a device for the calibrating of plastic profiles which does not necessitate application of a vacuum generated by air evacuation, and which thus presents enormous advantages regarding investment costs of the production line and operational costs. Especially the elimination of vacuum pumps will lead to drastic savings of energy (up to 80% of the energy requirement of a calibrating table) and will thus also meet ecological criteria.

According to the invention these objects are achieved by providing that the sleeve be furnished with at least one thin-walled section separating the interior passage of the sleeve from the interior space of the housing and that in this section openings are positioned which connect the passage with the interior space of the housing.

An essential point of the present invention is that it presents a substantial simplification over conventional dry calibrators and that cooling is significantly faster. As described above the invention represents a dry calibrating device which may be positioned immediately downstream of an extruder nozzle to perform the first cooling and calibrating step on the extruded profile which is not yet dimensionally stable. High surface quality of the profile can be guaranteed since direct contact of the still soft profile surface with the cooling medium is avoided.

The interior space of the device which is filled with the cooling medium is separated from the profile by means of the sleeve. In order to ensure the conforming fit of the profile against the sleeve only small openings are provided in the sleeve, with the invention defining a small opening as an opening whose dimension is small enough to prevent the cooling medium from wetting the profile wall. Wetting is here dependent on the low pressure, which usually is roughly 0.2 bar below ambient pressure, and the surface tension of the cooling medium on the PVC surface of the profile.

The openings may partly be configured as bores, i.e. round, or as slits, which usually are positioned at a right angle to the direction, of extrusion. In the case of bores the diameter preferably is 0.5 mm, dimensions of up to 1.0 mm, in special cases up to 1.5 mm, being possible, while in the case of slits the width is less than 1.0 mm, and preferably less than 0.7 mm. Via the openings a low pressure is generated in the gap between sleeve and profile and thus accurate calibration and a suitable quality of the surface are achieved. The openings are thus located primarily in areas of the sleeve corresponding to profile areas which are visible when the profile is in use and which must therefore have a particularly high surface quality.

In a preferred variant of the invention the proposal is put forward that the sleeve have a wall-thickness of less than 6%, and preferably less than 3%, of the diameter of the profile to be processed. Due to the openings the pressure differences between the two sides of the sleeve and thus the mechanical load will be small. A thin-walled configuration may therefore be chosen for the sleeve, which will result in particularly efficient heat transfer.

The gap between the profile and the sleeve Is never tightly sealed. This is due on the one hand to the motion of the profile through the sleeve and on the other hand in a larger degree to clearances, i.e. regions where the profile does not fit tightly against the sleeve In order to reduce friction or to avoid damage to projecting parts of the profile. Clearances of this sort are for instance provided in areas where the profile has projecting ribs. The openings in the sleeve together with the gap between sleeve and profile give rise to a pressure drop which In turn generates an air flow—of relatively small volume—from both front ends of the device along the profile surface and into the sleeve openings. This surplus air is removed from the interior space of the device together with the cooling medium and is extracted from the cooling medium in an air separator. This weak air flow is desirable and advantageous for the calibrating process. A further improvement may be obtained in a preferred variant of the invention by providing the sleeve, in addition to the openings mentioned, with at least one additional air feeder opening, which is connected to an air chamber. The tuning possibilities of the calibrator may be improved in particular by connecting the air feeder opening to the air chamber via an air feeder line having a control valve. In this variant it is thus possible to introduce a small volume of air not only via the entry, and exit openings but also from the interior of the device.

To increase the flow velocity of the cooling medium and thus heat transmission, flow guiding elements are provided in a preferred variant of the invention.

A particularly advantageous variant of the invention proposes that the housing and the sleeve consist of a plurality of parts and can be disassembled during operation. Depending on the complexity of the profile to be produced the sleeve may consist of two or more parts, with partitioning faces being preferably parallel to the longitudinal axis, i.e. to the direction of extrusion. In this context it is not strictly necessary that the sleeve parts be detachable from housing parts during operation, but it will be of advantage for the flexibility of production If the sleeve can be detached from the housing in principle. It is of course essential that the parts seal tightly against each other to ensure safe operation and maintain the low pressure required.

It is to be particularly preferred if a plurality of housings are positioned on a common ground plate one behind the other and aligned in longitudinal direction. This will permit to jointly introduce a plurality of dry calibrators mounted on a common ground plate into the extrusion line or to remove them from the line, thereby reducing change-over time and enhancing precision. By suitably connecting the calibrators within the group, the number of necessary external connectors can be reduced.

A particularly advantageous variant provides that the outflow opening be connected to a self-priming water pump in order to create the low pressure in the interior space. The elimination of vacuum pumps on the one hand simplifies the configuration of the calibrating table and on the other hand significantly reduces the energy requirement. As described above the water pumps will suck in the cooling medium together with any surplus air and will thus create the required low pressure in the interior chamber.

It is particularly advantageous if the sleeve openings are configured as slits on the interior wall of the sleeve, which communicate with the outside of the sleeve via bores. In this variant the slits are milled into the inner wall of the sleeve but do not penetrate the sleeve. This will distribute the low pressure over a larger area of the profile without opening up unduly large cross-sections. It will also improve the mechanical stability of the sleeve.

The present invention will be further described below by way of examples, with reference to the drawings, in which

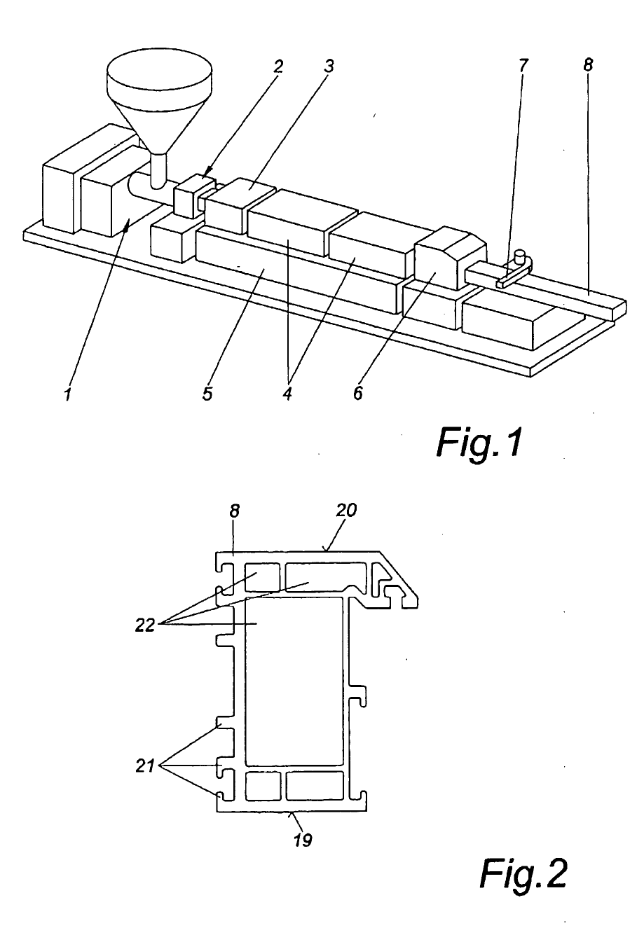

FIG. 1 is a general presentation of an extrusion line In an axonometric view;

FIG. 2 shows a cross-section of a typical plastics profile;

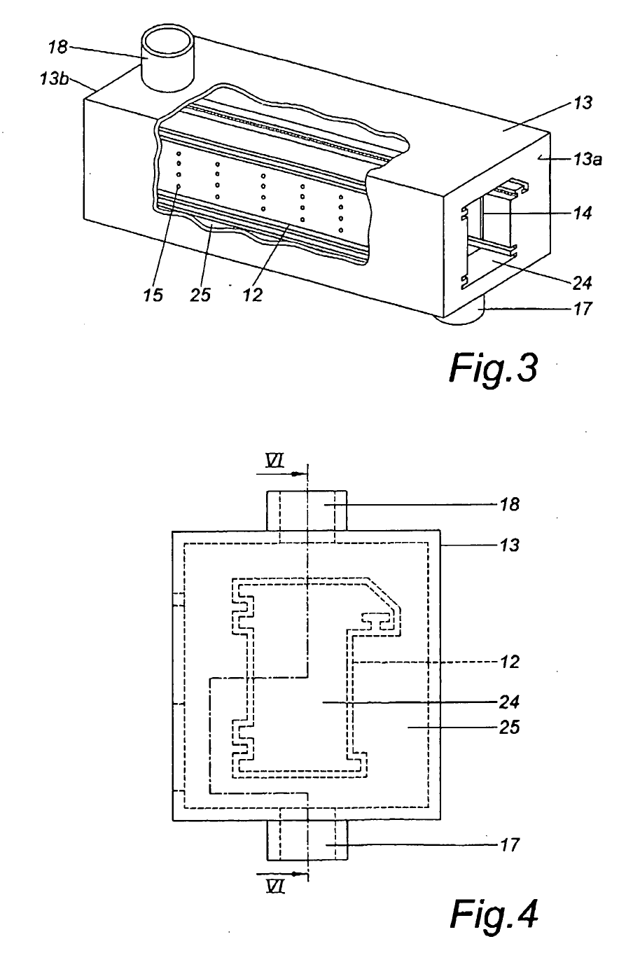

FIG. 3 is an axonometric view of a device according to the invention;

FIG. 4 shows a cross-section through a device according to the invention;

FIG. 5 is a side view of the device of FIG. 4;

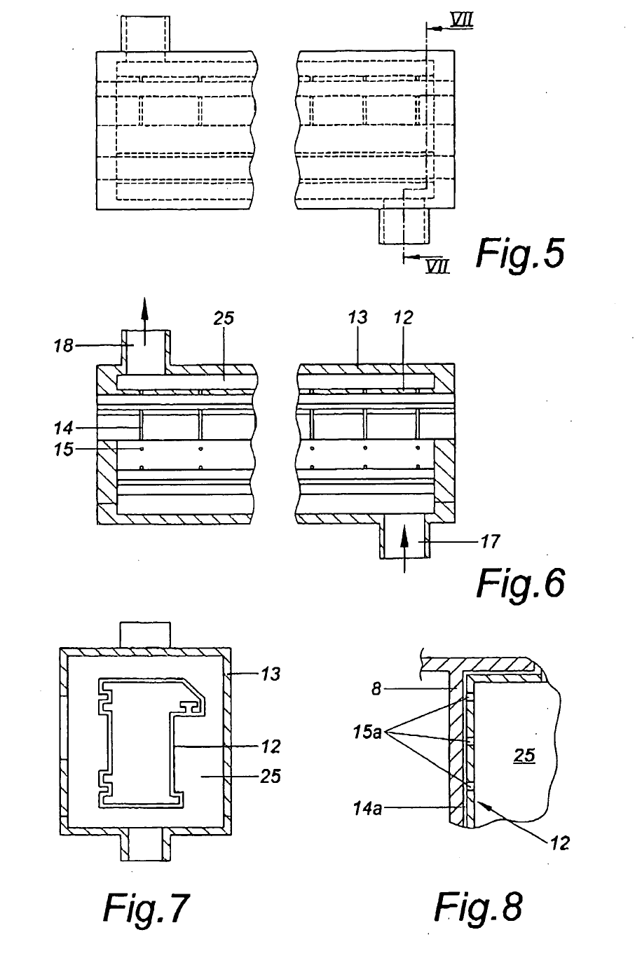

FIG. 6 shows a section along line VI-VI in FIG. 4;

FIG. 7 shows a section along the line VII-VII in FIG. 5;

FIG. 8 is a sectional view of a detail of a particular variant.

The extrusion line of FIG. 1 consists of an extruder with an extruder nozzle 2, and an adjacent calibrating table 5 carrying a dry calibrator 3 and two cooling tanks 4. Downstream of the calibrating table 5 a caterpillar belt puller 6 is provided which is followed by a saw 7. The profile itself is indicated by reference number 8 in this drawing.

FIG. 2 shows a cross-section of the profile 8. The visible surfaces of the profile 8 are marked 19 and 20, rib-like projections 21 serve to improve rigidity and to hold sealing elements not shown in the drawing. The hollow chambers of the profile 8 are marked 22.

A state-of-the-art dry calibrator consists of the calibrator block, which is composed of a number of parts. In the calibrator block cooling water bores are located lengthwise to cool the profile. In order to ensure conforming fit of the profile against the calibrating block vacuum slits are provided, which are connected to a vacuum pump via vacuum bores. It is a disadvantage of this known device that the temperature distribution frequently is non-uniform. This may impair the quality of the finished profile.

FIG. 3 shows a device according to the Invention, with part of the side wall broken away for better understanding. The device consists of a housing 13 with front faces 13a, 13b between which the sleeve 12 extends. The sleeve 12 is provided with a plurality of openings, which are configured as bores 15 or as slits 14. These openings 14, 15 connect the interior passage 24 of the sleeve 12 with the interior space 25 of the device, i.e. the space between the sleeve 12 and the housing 13.

This interior space 25 communicates with an outflow opening 18 for the cooling medium, which opening is in turn connected to a self-priming water pump (not shown in the drawing), which sucks off the cooling medium and such air as might be present in the interior space, and creates the required low pressure. The drained cooling medium is replenished via a controllable inflow opening 17.

The variant of FIG. 8 proposes slits 14a in the sleeve 12 having a depth of only half the wall thickness of the sleeve 12. Towards the outside the slits 14a communicate with the interior space 25 only via bores 15a. In this way an optimum distribution of the vacuum can be achieved with a small effective cross-sectional area, which is determined by the number and diameter of the bores 15a.

The present invention presents a dry calibrating device with improved cooling speed, which permits higher extrusion speeds and a reduced overall length of the extrusion line. At the same time profile quality is enhanced. As an additional effect energy is conserved due to the elimination of conventionally required vacuum pumps.

1.-13. (canceled)

14. A device for cooling and calibrating plastic profiles, comprising
a housing having an entry opening and an exit opening for a profile to be processed;
a sleeve disposed within the housing which connects the entry opening and the exit opening and encloses a passage essentially corresponding to the outer contour of the profile and containing the profile to be guided, said sleeve completely surrounding the profile inside the device;
a vacuum system for generating a vacuum in the gap between profile and sleeve, which is connected to small openings provided in the sleeve; and
at least one interior space which is filled with a cooling medium during operation of the device and is provided with an inflow opening and an outflow opening for cooling medium such that a flow of the cooling medium can be generated in the interior space;
wherein the sleeve includes at least one thin-walled section separating the passage from the interior space, and openings are positioned in this section which connect the passage and the interior space.

15. A device according to claim 14, wherein the openings are at least partly configured as bores having a diameter of less than 1.0 mm.

16. A device according to claim 14, wherein the openings are at least partly configured as bores having a diameter between 0.5 and 0.7 mm.

17. A device according to claim 14, wherein the openings are at least partly configured as slits whose width is less than 1.0 mm.

18. A device according to claim 14, wherein the openings are at least partly configured as slits whose widths are about 0.7 mm.

19. A device according to claim 14, wherein the sleeve has a thickness of less than 6% of the diameter of the profile to be processed.

20. A device according to claim 14, wherein the sleeve has a thickness of less than 3% of the diameter of the profile to be processed.

21. A device according to claim 14, wherein the sleeve, in addition to the openings, includes at least one air feeder opening which communicates with an air chamber.

22. A device according to claim 21, wherein the air feeder opening is connected to the air chamber via an air feeder line in which is disposed a control valve.

23. A device according to claim 14, wherein flow guiding elements are provided in the interior space.

24. A device according to claim 14, wherein the housing and the sleeve consist of a plurality of parts and can be disassembled during operation.

25. A device according to claim 24, wherein centering means are provided for accurate alignment of the individual parts.

26. A device according to claim 14, wherein a plurality of housings are positioned on a common ground plate one behind the other and aligned in longitudinal direction.

27. A device according to claim 14, wherein the outflow is connected to a self-priming water pump in order to create the low pressure in the interior space.

28. A device according to claim 14, wherein the openings are located primarily in areas corresponding to the visible areas of the profile.

29. A device according to claim 14, wherein the openings are configured at least partly as slits on the interior wall of the sleeve, said slits communicating with the outside of the sleeve via bores.
